(19) United States
(12) Patent Application Publication
(10) Pub. No.: US 2017/0171733 A1
(43) Pub. Date: Jun. 15, 2017

(54) VEHICLE HEAD UNIT, USER TERMINAL AND METHOD FOR NOTIFICATION OF EMERGENCY STATE OF VEHICLE

(71) Applicant: Hyundai Motor Company, Seoul (KR)

(72) Inventor: Kyong Jo Jung, Yongin (KR)

(21) Appl. No.: 15/183,342

(22) Filed: Jun. 15, 2016

(30) Foreign Application Priority Data
Dec. 11, 2015 (KR) 10-2015-0176694

(51) Int. Cl. H04W 4/22; B60R 21/01; H04M 3/51; H04W 4/00; G08G 1/127; H04N 5/232; H04W 4/04

(52) U.S. Cl. CPC H04W 4/22; H04N 5/23203; B60R 21/01; H04W 4/046; H04W 4/008; G08G 1/127; H04M 3/5116

(57) ABSTRACT

A vehicle head unit providing an e-call service includes: an around-view monitor (AVM) photographing unit generating AVM images by photographing an around-view of a vehicle; a short-range communication unit transmitting the AVM images to a user terminal such that the AVM images are stored in a volatile memory of the user terminal; and a controller transmitting an alive signal indicating normal operation of the vehicle head unit such that the user terminal recognizes an event generation.

### CROSS-REFERENCE TO RELATED APPLICATION

This application claims the benefit of and priority to Korean Patent Application No. 10-2015-0176694, filed on Dec. 11, 2015, which is hereby incorporated by reference in its entirety as if fully set forth herein.

### BACKGROUND OF THE DISCLOSURE

Technical Field

The present disclosure relates generally to a vehicle head unit, a user terminal and a method of notification of an emergency state of a vehicle and, more specifically, to a vehicle head unit, a user terminal and a method of notification of an emergency state of a vehicle, which provide an e-call service for announcing an emergency state in case of a vehicle accident.

Discussion of the Related Art

Increasing numbers of recently released vehicles are equipped with an audio-video-navigation (AVN) system. The AVN system is a multimedia system for vehicles, which includes an audio system, a video system, and a navigation system integrated into one unit. The AVN system provides user convenience through the operation of various multimedia devices and enables efficient use of the internal space of a vehicle.

Recently released vehicles have also been equipped with various convenience systems for aiding in safe driving. Such convenience systems can warn drivers using sounds or images when dangerous situations are predicted and can automatically react to a dangerous situation to assist in safe driving.

Additionally, there is an e-call service that automatically transmits information, such as the current location of a vehicle, a value derived from a gyro sensor, whether airbags have been deployed, and the like to following vehicles, a service center, or an emergency rescue center when the vehicle is involved in an accident. The e-call service is expected to increase emergency situation handling speed and reduce deaths from traffic accidents in case of car accidents once infrastructure related thereto is completed and most vehicles are equipped with systems which provide such service.

However, a vehicle head unit configured to provide the e-call service may be instantaneously destroyed due to car accidents. In this case, the e-call service becomes useless since the vehicle head unit cannot transmit corresponding information.

### SUMMARY OF THE DISCLOSURE

An object of the present disclosure devised to solve the above problem lies in a vehicle head unit, a user terminal and a method of notification of an emergency state of a vehicle, which can notify a telematics center of information about occurrence of a vehicle accident even when the vehicle head unit cannot transmit the information due to the vehicle accident.

The technical problems solved by the present disclosure are not limited to the above technical problems, and those skilled in the art may understand other technical problems from the following description.

According to embodiments of the present disclosure, a vehicle head unit providing an e-call service includes: an around-view monitor (AVM) photographing unit generating AVM images by photographing an around-view of a vehicle; a short-range communication unit transmitting the AVM images to a user terminal such that the AVM images are stored in a volatile memory of the user terminal; and a controller transmitting an alive signal indicating normal operation of the vehicle head unit such that the user terminal recognizes an event generation.

Furthermore, according to embodiments of the present disclosure, a user terminal providing an e-call service includes: a volatile memory storing AVM images obtained by photographing an around-view of a vehicle within a predetermined storage capacity; a terminal controller recognizing an event generation based on an airbag deployment signal received from a vehicle head unit or an alive signal indicating normal operation of the vehicle head unit; and an RF communication unit transmitting images before and after an event generation time to a telematics center upon recognition of the event generation.

Furthermore, according to embodiments of the present disclosure, a method for notification of an emergency state of a vehicle includes: storing AVM images obtained by photographing an around-view of the vehicle within a predetermined storage capacity; recognizing an event generation based on an airbag deployment signal received from a vehicle head unit or an alive signal indicating normal operation of the vehicle head unit; and transmitting images before and after an event generation time to a telematics center upon recognition of the event generation.

According to the aforementioned vehicle head unit, user terminal, and method of notification of an emergency state of a vehicle according to embodiments of the present disclosure, the user terminal can transmit information about a vehicle accident to a telematics center even when the vehicle head unit does not normally operate, thereby enabling rapid follow-up measures.

In addition, it is possible to secure a crucial image of an accident even when black box images of the vehicle cannot be acquired due to a fatal accident or malicious theft of the black box.

Furthermore, it is possible to prevent bad blocks due to frequent writing by storing AVM images in a volatile memory only, thereby securing correct images before and after an accident.

The effects of the present disclosure are not limited to the above-described effects, and other effects which are not described herein will become apparent to those skilled in the art from the following description.

### BRIEF DESCRIPTION OF THE DRAWINGS

FIG. 1 illustrates a vehicle emergency state notification system according to embodiments of the present disclosure.

FIG. 2 is a block diagram illustrating a vehicle head unit shown in FIG. 1.

FIG. 3 is a block diagram illustrating a user terminal shown in FIG. 1.

FIG. 4 is a flowchart illustrating a vehicle emergency state notification method according to embodiments of the present disclosure.

### DETAILED DESCRIPTION OF THE EMBODIMENTS

Reference will now be made in detail to the embodiments of the present disclosure, examples of which are illustrated in the accompanying drawings. Although the suffixes “module” and “unit” are used for constituent elements described in the following description, this is intended only for ease of description in the specification.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Additionally, it is understood that one or more of the below methods, or aspects thereof, may be executed by at least one control unit. The term “control unit” may refer to a hardware device that includes a memory and a processor. The memory is configured to store program instructions, and the processor is specifically programmed to execute the program instructions to perform one or more processes which are described further below. Moreover, it is understood that the below methods may be executed by an apparatus comprising the control unit in conjunction with one or more other components, as would be appreciated by a person of ordinary skill in the art.

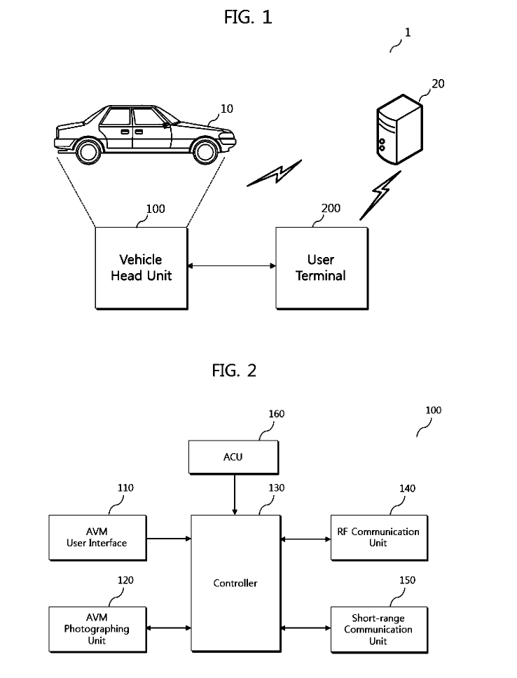

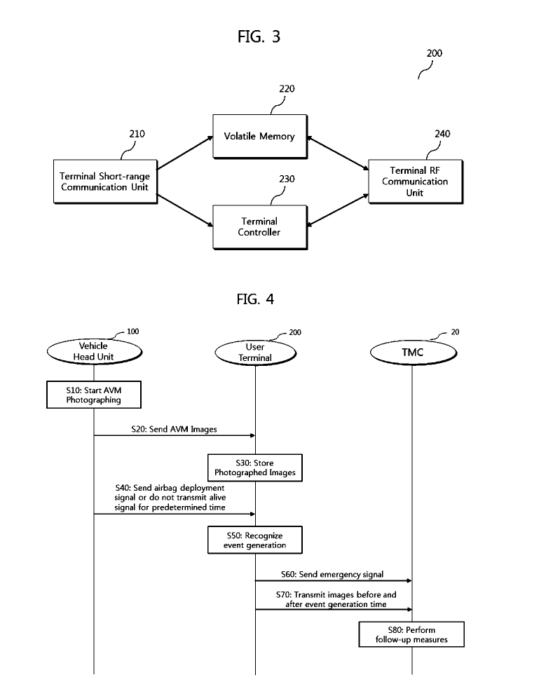

Referring now to the presently disclosed embodiments, FIG. 1 illustrates a vehicle emergency state notification system according to embodiments of the present disclosure, FIG. 2 is a block diagram illustrating a vehicle head unit shown in FIG. 1 and FIG. 3 is a block diagram of a user terminal shown in FIG. 1.

As shown in FIG. 1, the vehicle emergency state notification system 1 may include a vehicle 10, a telematics center (TMC) 20, a vehicle head unit 100, and a user terminal 200.

The vehicle 10 is equipped with the vehicle head unit 100 through which the e-call service can be provided thereto. The e-call service is a service that automatically transmits information, such as the current location of a vehicle, a value derived from a gyro sensor mounted in the vehicle, whether airbags have been deployed, and the like, to other vehicles, a service center, an emergency rescue center, and the like when the vehicle had an accident.

The telematics center 20 may provide a telematics service. The telematics service refers to a service that provides a navigation function, various multimedia functions such as burglar alarm, emergency recovery (SOS), remote diagnosis, management of supplies, hands-free cellular phone, living information, personal information, secretarial services and Internet access, a two-way Internet function, mobile services, and the like. Notably, the telematics service may include the e-call service.

The telematics center 20 may manage opening of services of the vehicle head unit 100, collect information that a user requires and transmit the information to the vehicle head unit 100 or transmit information received from the vehicle head unit 100 to a network operator server or corresponding organizations (e.g., an insurance company, an emergency rescue center, etc.).

The telematics center 20 may operate a database that stores and manages information of the vehicle 10, information of the vehicle head unit 100, map data and other information. The database may be provided inside (i.e., locally) or outside (i.e., remotely) of the telematics center 20.

The vehicle head unit 100 may be embedded or installed in the dashboard of the vehicle 10 and may provide multimedia services such as air-conditioning, controlling, audio, video and navigation services of the vehicle 10 and a service of connectivity with arbitrary terminals.

Referring to FIG. 2, the vehicle head unit 100 may include an around-view monitor (AVM) user interface 110, an AVM photographing unit 120, a controller 130, an RF communication unit 140, a short-range communication unit 150 and an airbag control unit (ACU) 160.

The AVM user interface 110 and the AVM photographing unit 120 are components for an AVM function which photographs an around-view of the vehicle 10 (i.e., a view of the environment that surrounds the vehicle) when the vehicle 10 is parked or started and provides a top view image of the vehicle 10 using the photographed image.

The AVM user interface 110 is a user interface provided to a user to control the AVM function. For example, the AVM user interface 110 can be implemented as a button electrically connected to the controller 130. An activation signal for activating the AVM function can be transmitted to the controller 130 when the button is pushed, whereas a deactivation signal for deactivating the AVM function can be transmitted to the controller 130 when the button is released.

The AVM photographing unit 120 may capture an around-view image of the vehicle 10 under the control of the controller 130 and transmit the captured image to the controller 130. Additionally, the AVM photographing unit 120 may send the captured image to the user terminal 200 via the short-range communication unit 1509 without passing through the controller 130.

The AVM photographing unit 120 may be implemented as cameras respectively provided to the front, rear, left and right sides of the vehicle 10 to photograph the around-view of the vehicle 10. Images photographed by the AVM photographing unit 120 may be transmitted through CAN communication in the vehicle 10. Accordingly, while the AVM photographing unit 120 is a component independent of the vehicle head unit 100 that can be embedded in the dashboard of the vehicle 10, the present specification is based on the assumption that the AVM photographing unit 120 is functionally a component of the vehicle head unit 100 for convenience of description.

The controller 130 may control the overall operation of the vehicle head unit 100. The controller 130 may operate the AVM photographing unit 120 upon reception of the signal for activating the AVM function from the AVM user interface and stop the operation of the AVM photographing unit 120 upon reception of the signal for deactivating the AVM function from the AVM user interface 110.

When the user activates the AVM function, the controller 130 combines around-view images of the vehicle 10, captured by the AVM photographing unit 120, and provides the combined images to the user such that the user can view the images through a display (not shown) when the vehicle 10 is parked or started.

When the vehicle 10 is not parked or started, the controller 130 may transmit the around-view images captured by the AVM photographing unit 120 to the short-range communication unit 150 or control the AVM photographing unit 120 to directly send the around-view images to the short-range communication unit 150.

The controller 130 may transmit an alive signal to the user terminal 200 through the short-range communication unit 150 at a predetermined interval (e.g., one second) upon confirmation of connection with the user terminal 200 through the short-range communication unit 150. The alive signal is a signal indicating that the vehicle head unit 100 is normally operating.

Whether the vehicle head unit 100 normally operates may be determined according to whether a signal generated by the controller 130 can be transmitted through the RF communication unit 140. Accordingly, the alive signal cannot be generated when power cannot be supplied to the vehicle head unit 100 due to collision of the vehicle 10 or when the controller 130 or the RF communication unit 140 is damaged and thus cannot execute functions thereof.

In addition, the controller 130 may transmit an emergency signal to the telematics center 20 through the RF communication unit 140 and to the user terminal 200 through the short-range communication unit 150 upon reception of an airbag deployment signal from the ACU 160.

The airbag deployment signal is a signal indicating that airbags installed in the vehicle 10 have been deployed due to collision of the vehicle 10. The emergency signal may be a short message service (SMS) message including the vehicle identification number of the vehicle 10, a unique number (e.g., telephone number) of the vehicle head unit 100, GPS information, personal information of the user (e.g., age, sex, blood type, etc.) and information about presence or absence of accident occurrence.

The RF communication unit 140 may relay data transmission and reception between a 3rd generation (3G) or long term evolution (LTE) mobile communication network and the controller 130. To this end, the RF communication unit 140 may perform protocol conversion, signal amplification, and noise cancellation.

The short-range communication unit 150 may transmit and receive data to and from the user terminal 200 through short-range communication such as wired connection, i.e., mobile high definition link (MHL), or wireless connection, i.e., Bluetooth, Wi-Fi, near field communication (NFC), etc.

The ACU 160 may control airbags installed in the vehicle 10 and generate the airbag deployment signal when the airbags need to be deployed. The ACU 160 can control the airbags to be deployed for safety of the driver and passengers upon sensing impact exceeding a threshold value through an impact sensor provided to a specific position of the vehicle 10. When the airbags are deployed, the ACU 160 can generate the airbag deployment signal and transmit the airbag deployment signal to the controller 130.

The airbag deployment signal may be transmitted through CAN communication in the vehicle 10. Accordingly, while the ACU 160 is a component independent of the vehicle head unit 100 that can be embedded in the dashboard of the vehicle 10, the present specification is based on the assumption that the ACU 160 is functionally a component of the vehicle head unit 100 for convenience of description.

The user terminal 200 may be implemented as a portable user device, such as a cellular phone, a smartphone, a tablet PC, a notebook PC, a wearable device, etc. While the user terminal 200 can be provided to the inside of the vehicle 10 since the user terminal 200 is carried by the user riding in the vehicle 10, the scope of the present disclosure is not limited thereto.

Referring to FIG. 3, the user terminal 200 may include a terminal short-range communication unit 210, a volatile memory 220, a terminal controller 230, and a terminal RF communication unit 240.

The terminal short-range communication unit 210 may execute substantially the same function as the short-range communication unit 150 mentioned with reference to FIG. 2.

The terminal short-range communication unit 210 may receive images, photographed by the AVM photographing unit 120, from the vehicle head unit 100 and send the images to the volatile memory 220. In addition, the terminal short-range communication unit 210 may receive the airbag deployment signal or the alive signal from the vehicle head unit 100 and send the received signal to the terminal controller 230.

While separation of signals received from the vehicle head unit 100 may be controlled by the terminal controller 230, the scope of the present disclosure is not limited thereto.

The volatile memory 220 is a memory that maintains data stored therein during power supply and deletes the stored data when power is cut. A non-volatile memory such as a flash memory is likely to generate a bad block in which desired data cannot be stored when the number of times of writing data into a specific memory block and the number of times of reading data from the specific memory block become close to lifetime limits. However, the volatile memory 220 has a remarkably lower possibility of generation of a bad block than the non-volatile memory in spite of repeated writing and reading. The volatile memory 220 can be implemented as a dynamic random access memory (DRAM), a static random access memory (SRAM), or the like.

The volatile memory 220 may store images photographed by the AVM photographing unit 120 and received from the terminal short-range communication unit 210. However, the volatile memory 220 can store the photographed images only within storage capacity set under the control of the terminal controller 230. While the set storage capacity may amount to a portion of the photographed images, which corresponds to 20 seconds, the scope of the present disclosure is not limited thereto.

Therefore, in order to continuously store the photographed images sequentially transmitted to the volatile memory 220, the volatile memory 220 can sequentially delete images stored therein, starting from the initially stored image, when the stored images reach the storage capacity, and store sequentially transmitted images in the memory region from which the stored images have been deleted.

When the terminal controller 230 recognizes event generation, which will be described in further detail below, the volatile memory 220 may be controlled by the terminal controller 230 to store and maintain images corresponding to a predetermined time before and after event generation time.

For example, when the terminal controller 230 recognizes event generation, the terminal controller 230 can control the volatile memory 220 to additionally store images corresponding to 10 seconds after event generation time and to skip images transmitted after 10 seconds from the event generation time. Accordingly, when the set storage capacity corresponds to images for 20 seconds, for example, the volatile memory 220 can store images corresponding to 10 seconds before the event generation time and images corresponding to 10 seconds after the event generation time.

The terminal controller 230 may receive the airbag deployment signal and the alive signal from the terminal short-range communication unit 210 and recognize event generation based on the airbag deployment signal and the alive signal. Event generation refers to an accident of the vehicle 10 or a situation in which the vehicle head unit 100 cannot normally operate.

Specifically, the terminal controller 230 may recognize that the vehicle 10 has been an accident upon reception of the airbag deployment signal and recognize that the vehicle head unit 100 cannot normally operate when the alive signal that needs to be transmitted at a specific interval (e.g., one second) is not received for a predetermined time (e.g., five seconds).

The terminal controller 230 may control the volatile memory 220 to store and maintain images corresponding to a predetermined time before and after the event generation time upon recognition of the event generation.

After the volatile memory 220 has stored the images (referred to herein as “images before and after the event generation time”) corresponding to a predetermined time before and after the event generation time, the terminal controller 230 may control the images before and after the event generation time, stored in the volatile memory 220, to be sent to the telematics center 20 through the terminal RF communication unit 240.

In addition, the terminal controller 230 may generate an emergency signal independently of the vehicle head unit 100 and send the emergency signal to the telematics center 20 through the terminal RF communication unit 240.

The emergency signal may be an SMS message including the vehicle identification number of the vehicle 10, a unique number (e.g., telephone number) of the vehicle head unit 100, GPS information, personal information of the user (e.g., the age, sex, blood type, etc.) and information about presence or absence of accident occurrence, like the aforementioned emergency signal generated by the controller 130. To generate the emergency signal, the terminal controller 230 may receive information related to the vehicle 10 from the controller 130 when initially connected to the short-range communication unit 150 and store the information in a separate memory (non-volatile memory).

The terminal RF communication unit 240 may execute substantially the same function as the RF communication unit 140 aforementioned with reference to FIG. 2.

The terminal RF communication unit 240 may send the images before and after the event generation time, received from the volatile memory 220, and the emergency signal received from the terminal controller 230 to the telematics center 20 through a mobile communication network.

The telematics center 20 may receive the images before and after the event generation time and the emergency signal and take follow-up measures based on the received signals. That is, the telematics center 20 can check the images before and after the event generation time so as to recognize correct situations and details of the accident of the vehicle 10 upon reception of the emergency signal and then rapidly request emergency rescue services (e.g., dialing 911) suitable for the situations and details of the accident.

FIG. 4 is a flowchart illustrating a vehicle emergency state notification method according to embodiments of the present disclosure.

As shown in FIG. 4, when the user activates the AVM function through the AVM user interface 110, the AVM photographing unit 120 may generate around-view images (referred to herein as “AVM images”) of the vehicle 10 (S10).

The vehicle head unit 100 may send the AVM images to the user terminal 200 (S20).

The volatile memory 220 of the user terminal 200 may store images photographed by the AVM photographing unit 120 and received from the terminal short-range communication unit 210 (S30). The volatile memory 220 can store the photographed images within storage capacity set under the control of the terminal controller 230.

Upon generation of an airbag deployment signal due to collision of the vehicle 10, the vehicle head unit 100 may transmit the airbag deployment signal to the user terminal 200 or may not send the periodically transmitted alive signal for a predetermined time (e.g., five seconds) due to abnormality of the vehicle head unit 100 (S40).

The user terminal 200 may generate an emergency signal upon recognition of the situation of step S40, that is, event generation, and control the volatile memory 220 to store images before and after the event generation time (S50).

The user terminal 200 may transmit the emergency signal to the telematics center 20 (S60) and, after the volatile memory 220 has stored the images before and after the event generation time, send the images before and after the event generation time to the telematics center 20 (S70).

The telematics center 20 may receive the images before and after the event generation time and the emergency signal and take follow-up measures based on the received signals (S80).

According to the embodiments of the present disclosure, the user terminal 200 can deliver information about a vehicle accident to the telematics center 20 to enable rapid follow-up measures even when the vehicle head unit 100 does not normally operate. In addition, it is possible to secure a crucial image of an accident even when black box images of the vehicle cannot be acquired due to a fatal accident or malicious theft of the black box. Furthermore, it is possible to prevent generation of a bad block due to frequent writing by storing AVM images only in the volatile memory 220, thereby securing correct images before and after an accident.

The aforementioned method may be implemented as computer-readable code stored in a computer-readable recording medium. The computer-readable recording medium includes all kinds of recording media storing data readable by a computer system. Examples of the computer-readable recording medium include a ROM, a RAM, a magnetic tape, a magnetic disk, a flash memory, an optical data storage device and the like. In addition, the computer-readable recording medium may be distributed to computer systems connected through a computer communication network, stored and executed as code readable in a distributed manner.

Although exemplary aspects of the present disclosure have been described for illustrative purposes, those skilled in the art will appreciate that various modifications, additions and substitutions are possible, without departing from essential characteristics of the disclosure. Thus, embodiments disclosed herein are only exemplary and not to be considered as limitative of the disclosure. Accordingly, the scope of the disclosure is not to be limited by the above aspects but by the claims and the equivalents thereof.

What is claimed is:

1. A vehicle head unit providing an e-call service, comprising:
an around-view monitor (AVM) photographing unit generating AVM images by photographing an around-view of a vehicle;
a short-range communication unit transmitting the AVM images to a user terminal such that the AVM images are stored in a volatile memory of the user terminal; and
a controller transmitting an alive signal indicating normal operation of the vehicle head unit such that the user terminal recognizes an event generation.

2. The vehicle head unit according to claim 1, wherein the AVM photographing unit continuously generates the AVM images when an AVM function is activated.

3. The vehicle head unit according to claim 1, wherein the controller receives an airbag deployment signal from an airbag control unit (ACU) and sends the airbag deployment signal to the user terminal through the short-range communication unit.

4. The vehicle head unit according to claim 1, wherein normal operation of the vehicle head unit is determined according to whether a signal generated by the controller is transmitted through an RF communication unit.

5. The vehicle head unit according to claim 1, wherein the short-range communication unit transmits and receives data to and from the user terminal using Bluetooth.

6. A user terminal providing an e-call service, comprising:
a volatile memory storing AVM images obtained by photographing an around-view of a vehicle within a predetermined storage capacity;
a terminal controller recognizing an event generation based on an airbag deployment signal received from a vehicle head unit or an alive signal indicating normal operation of the vehicle head unit; and
an RF communication unit transmitting images before and after an event generation time to a telematics center upon recognition of the event generation.

7. The user terminal according to claim 6, wherein the terminal controller recognizes the event generation according to whether the airbag deployment signal is received or whether the alive signal is not received for a predetermined time.

8. The user terminal according to claim 6, wherein the terminal controller generates an emergency signal upon recognition of the event generation, the emergency signal including at least one of: a vehicle identification number of the vehicle, a unique number of the vehicle head unit, GPS information, personal information of a user, and information about presence or absence of accident occurrence.

9. The user terminal according to claim 6, wherein, when the AVM images have been stored in a memory region corresponding to the predetermined storage capacity, the volatile memory sequentially deletes the stored images, starting from an initially stored image, and stores sequentially received AVM images.

10. The user terminal according to claim 6, wherein the terminal controller controls the volatile memory so as to store images corresponding to a predetermined time after the event generation time and then controls the volatile memory so as to skip following images, upon recognition of the event generation.

11. The user terminal according to claim 6, further comprising a terminal short-range communication unit configured to transmit and receive data to and from the vehicle head unit using Bluetooth.

12. A method for notification of an emergency state of a vehicle, comprising:
storing AVM images obtained by photographing an around-view of the vehicle within a predetermined storage capacity;
recognizing an event generation based on an airbag deployment signal received from a vehicle head unit or an alive signal indicating normal operation of the vehicle head unit; and
transmitting images before and after an event generation time to a telematics center upon recognition of the event generation.

13. The method according to claim 12, wherein the recognizing of the event generation comprises recognizing the event generation according to whether the airbag deployment signal is received or whether the alive signal is not received for a predetermined time.

14. The method according to claim 12, further comprising generating an emergency signal upon recognition of the event generation, the emergency signal including at least one of: a vehicle identification number of the vehicle, a unique number of the vehicle head unit, GPS information, personal information of a user, and information about presence or absence of accident occurrence.

15. The method according to claim 12, wherein the storing of the AVM images comprises sequentially deleting stored images, starting from an initially stored image, and storing sequentially received AVM images when the AVM images have been stored in a memory region corresponding to the predetermined storage capacity.

16. The method according to claim 12, wherein the storing of the AVM images comprises storing images corresponding to a predetermined time after the event generation time, and then skipping following images, upon recognition of the event generation.
